(19) United States
(12) Patent Application Publication
(10) Pub. No.: US 2020/0114612 A1
(43) Pub. Date: Apr. 16, 2020

(54) CONTAINER WITH ADHESIVE INTERACTION PORTION, METHOD AND BLANK FOR FORMING THE SAME

(71) Applicant: PHILIP MORRIS PRODUCTS S.A., Neuchatel (CH)

(72) Inventors: Digvijay Singh, Pully (CH); Timothee Cailleaux, Divonne-les-Bains (FR); Harman Vorenkamp, Auenwald (DE)

(21) Appl. No.: 16/615,684

(22) PCT Filed: May 18, 2018
(86) PCT No.: PCT/EP2018/063151

§ 371 Date: Nov. 21, 2019

(30) Foreign Application Priority Data
May 23, 2017 (EP) 17172488.3

(51) Int. Cl. B31B 50/62; B31B 50/88; B31B 50/25; B65D 85/10

(52) U.S. Cl. CPC B31B 50/626; B31B 50/624; B31B 2105/0027; B31B 50/25; B65D 85/1045; B31B 50/88

(57) ABSTRACT

The invention provides a method of forming a container for aerosol generating articles, wherein a blank comprising at least one panel is provided, wherein the surface structure of the panel is opened in a central adhesive receiving area, before or after a local height variation in the panel is created by embossing, wherein the local height variation extends as an outer fluid guide element at least partially at the outside of the central adhesive receiving area. The central adhesive receiving area and the outer fluid guide element form an adhesive interaction portion in the panel. The invention further relates to a blank for forming a container, wherein the blank comprises several panels, and wherein at least one panel comprises an adhesive interaction portion, and to a container for consumer goods, formed from an according blank.

The present invention relates to a method of forming a container for aerosol generating articles, to a blank for forming a container, wherein the blank comprises several panels, and wherein at least one panel comprises an adhesive interaction portion, and to a container for consumer goods, formed from an according blank.

It is known to use adhesive to connect different parts of packages or to connect further components to packages. International patent application WO 2008/142540 A1 discloses an inner liner cover flap connected to the lid of a package of tobacco articles.

Furthermore, packaging machines are known. U.S. Pat. No. 5,628,162 discloses machines for packaging cigarettes in packs, cartons and boxes. In the prior art, it is known to provide structures which interact with adhesive. For example, International patent application WO 2014/082717 A1 discloses a container with fluid guide elements, which provide that adhesive can be distributed in a certain area along the fluid guide elements, but is then stopped by another fluid guide element.

However, it is difficult to enable a strong adhesive connection, while enabling high speed manufacture in a reliable machine, and to avoid that adhesive travels to undesired locations.

The present invention has the object of overcoming these drawbacks and providing an improved adhesive connection.

The invention provides a method of forming a container for aerosol generating articles, wherein a blank comprising at least one panel is provided, wherein the surface structure of the panel is opened in a central adhesive receiving area, before, at the same time or after a local height variation in the panel is formed, wherein the local height variation extends as an outer fluid guide element at least partially at the outside of the central adhesive receiving area. The central adhesive receiving area and the outer fluid guide element form an adhesive interaction portion in the panel.

The container is in particular a package for aerosol generating articles. The aerosol generating articles may be smoking articles, such as for example cigarettes. Alternatively, the aerosol generating articles may be devices which heat tobacco or fluid to provide an aerosol, or articles provided in these devices, such as tobacco rods or vaporization liquid containers.

The term “local” is to be understood that the height variation is only provided in a portion of the panel, while the remaining panel is free of the height variation. The local height variation may for example be a local depression or a locally raised area. A local depression may be a structure created by embossing or creasing. The locally raised area may be created by locally applying additional material, such as lacquer, or by embossing from the rear side of the panel resulting in a raised relief structure in the panel.

According to the invention, the adhesive interaction portion interacts preferably in the following manner with the adhesive. While the adhesive is still in a liquid state, the central adhesive receiving area supports the distribution of the adhesive, in particular by providing flow paths, which enable the flow of adhesive when the adhesive is subject to the pressure in between the panel and a further component which is fixed to the panel by means of the adhesive. Furthermore, the adhesive interaction portion enables to guide or restrict the flow of adhesive by creating obstacles to the flow of adhesive, which may range from roughened areas to areas in the form of local protrusions.

In particular, mainly the local height variation is adapted to provide for the promotion and restriction of the flow of adhesive, to enable a desired distribution of the adhesive.

The fluid guide element preferably promotes the flow of adhesive into the local height variation, if the local height variation is formed as a local depression, or it enables to stop the flow of adhesive like a barrier, if the local height variation is formed as a locally raised area.

The opening of the surface structure of the panel increases its surface. The increased surface enables a better bonding with the adhesive, as the adhesive is in contact with a larger surface with varying normal directions. The opening of the surface may be obtained by providing full or partial cuts or incisions or scratchings therein. In particular, the opening of the surface of the panel may be realized by increasing the surface of the panel by roughening or cutting same.

The open surface structure may contribute to the effect of promotion and restriction of the adhesive flow. Depending on the direction of the openings and the differences in roughness compared to the unopened surface, the flow of adhesive may be influenced. In particular the flow of adhesive may be promoted in the direction of the extension of the openings.

Preferably, the fluid guide element is continuous but at least partially non-linear, such that it at least partially encompasses the central adhesive receiving area. The non-linear parts of the fluid guide element may be curves or corners. Thus, the fluid guide element may be a line which changes direction along its extension in a differentiable or at least continuous manner.

The at least partially encompassing of the central adhesive receiving area by the fluid guide element may be enabled by a fluid guide element which extends around more than 180 degrees of the perimeter of the central adhesive receiving area, as seen from a point in the central adhesive receiving area. The aforementioned point is in particular a central point in the adhesive interaction portion. There may be a distance in between the perimeter of the adhesive receiving area and the fluid guide element. The arrangement of the continuous fluid guide element at least partially around the central adhesive receiving area enables to ensure that the adhesive remains and is distributed in the whole of the central adhesive receiving area, while preventing or reducing the flow over the fluid guide element into undesired regions of the panel.

Preferably, the step of opening the surface structure of the panel in the central adhesive receiving area comprises cutting the panel in the adhesive receiving area.

“Cutting” is to be understood as to sever the structure of the panel at least locally along a straight or curved line, for example by severing fibers of a panel formed out of paper or cardboard. Cutting the panel may comprise providing full or partial incisions in the panel, in particular by a knife. A partial incision is an incision which extends only partially through the thickness of the sheet-like panel.

In one embodiment, the step of opening the surface structure of the panel in a central adhesive receiving area comprises scratching or roughening the panel in the adhesive receiving area. This enables to increase the surface of the surface receiving area, enabling a better bond with the adhesive. Furthermore, a roughened surface enables to change the flow properties of the adhesive, such that the distribution of the adhesive can be influenced.

The present invention further provides a blank for forming a container, wherein the blank comprises several panels, and wherein at least one panel comprises an adhesive interaction portion, wherein the adhesive interaction portion comprises an adhesive receiving area which is at least partially encompassed by a continuous, at least partially non-linear fluid guide element.

The at least partially encompassing by the continuous fluid guide element enables that the fluid guide element extends at least around 180 degrees as seen from a point in the adhesive interaction portion. The non-linear fluid guide element is preferably formed along a non-linear curve or a polygonal chain or combinations of curves and polygonal chains, which at least locally comprises a curvature or abrupt changes in direction or combinations of curvature and abrupt changes in direction. The non-linear fluid guide element extends along a continuous and potentially differentiable curve.

The blank according to the invention enables that adhesive is beneficially distributed and prevented from flowing into undesired areas, and that a strong bond in between the panel with the adhesive interaction portion and a further component can be obtained.

Remarkably, the flow guiding properties of both the adhesive interaction portion and fluid guide element enable a reliable distribution of glue, while the adhesive interaction portion additionally improves the bonding with the adhesive.

In one embodiment, the fluid guide element fully and continuously encompasses the adhesive receiving area. This means that the fluid guide element extends continuously and fully around the adhesive receiving area. Thus, the fluid guide element can reliably prevent or reduce the escape of adhesive in any direction from the adhesive receiving area.

In one embodiment, the fluid guide element is formed by a depression in the panel. Preferably, the depression is formed by embossing or scoring. In other embodiments, the fluid guide element may be formed by a locally raised area, which could be created by the local application of further material, such as lacquer, on top of the panel or by embossing performed on the opposite side of the panel. The depression may act as an adhesive reservoir, preferably receiving surplus adhesive.

The fluid guide element may be formed by two parallel depressions in the panel. This enables to safely prevent the flow of adhesive over the fluid guide element. In some embodiments, the fluid guide element may be formed by two parallel protrusions in the panel.

Preferably, in the adhesive receiving area, the surface structure of the panel is opened. This means that the otherwise preferably flat and smooth surface of the panel is roughened or provided with local cuts or incisions. This increases the surface area of the panel and provides for a better adhesive connection.

In one embodiment, several subsequent incisions along a line are provided in the adhesive receiving area. Instead of the straight line, in some embodiments the subsequent incisions may extend along a curve or a polygonal chain. The incisions increase the surface of the adhesive receiving area, and support the fluid flow in their extension direction.

Preferably, incisions in several parallel lines or curves are provided in the adhesive receiving area. This enables that a strong and homogenous adhesive connection throughout the area provided with the parallel lines or curves of incisions is enabled, mainly due to increased bonding surface and equal distribution of the adhesive. In particular, the several parallel lines or curves may be arranged equidistantly.

In one embodiment, the several subsequent incisions have the same length and same distance to each other along their line, curve or respective lines or curves.

Preferably, the incisions are angled with respect to the grain direction of the blank material, in particular with respect to the fiber direction of paper or cardboard material used for the blank. This enables that the material is opened more effectively, as in particular the fibers are severed. Advantageously, for board material, this improves the access to the fibers for the adhesive and thus a stronger connection with the blank material.

The invention further provides a container for consumer goods, formed from a blank as defined above, wherein the container wall is formed from at least one of the panels, and wherein adhesive is provided in the adhesive receiving area of the adhesive interaction portion.

In particular, a further component of the container, such as another panel of the blank, may be connected by means of the adhesive to the adhesive interaction portion.

In one embodiment, the further component of the container is a cover flap of an inner liner, and the adhesive connects the cover flap of the inner liner to a lid of the container.

Preferably the inner liner encloses a bundle of consumer goods, in particular aerosol generating articles, and is arranged in between the consumer goods and the container walls. The inner liner may be provided to preserve the freshness of the consumer goods in the container. To enable that the inner liner is re-closable, the inner liner comprises an opening which may be closed with the cover flap. The cover flap or inner liner or both the cover flap and the inner liner may be provided with non-permanent adhesive around the opening to enable a substantially gas-tight reclosing of the inner liner by means of the cover flap.

The cover flap may be an integral part of the same material as the inner liner, or it may be a separate label of the same or different material applied on the inner liner. As a separate label, the cover flap is preferably fixed at one side of the cover flap with permanent adhesive to the inner liner.

In one embodiment, the container is a hinged-lid container, and the cover flap is connected to the inner side of the front wall of the lid. In particular, the side of the cover flap opposite from its connection to the inner liner may be connected by the adhesive to the lid of the container. This enables that the cover flap is lifted from the inner liner when the container is opened by hinging the lid. When the lid is closed again, the cover flap is brought back into its closing position, that is, the position where it closes the opening in the inner liner.

In another embodiment, the cover flap may be fixed by adhesive in the adhesive interaction portion to the lid of a container with separate lid.

In another embodiment, the container may be a slide-and-shell container, which is opened and closed by sliding the slide relative to the shell. The cover flap may be fixed by adhesive to the adhesive interaction portion of the slide or shell. Additionally, the inner liner may be fixed to the other of slide and shell, preferably also via another adhesive interaction portion.

The fixation of the cover flap to the adhesive receiving area enables the opening and re-closing of the inner liner by means of the cover flap when opening and closing the container.

Preferably, the blank is made of a different material than the further component, in particular the cover flap. In a preferred embodiment, the blank is made of cardboard and the cover flap comprises a polymer film, in particular a metallised film. This is beneficial for the properties of the container, as cardboard provides the necessary dimensional stability, and the polymer film of the cover flap provides the necessary impermeability to preserve the freshness of the consumer goods, while being flexible for being opened and closed multiple times.

A connection in between different materials by means of adhesive is usually difficult to obtain, as the adhesive is usually optimized for one type of material only. However, by providing the adhesive interaction portion, the distribution and connection of the adhesive can be significantly improved, even if the panel provided with same is not of the designated material for the respective adhesive. Thus, the adhesive may be optimized for the material of the further component, in particular the cover flap.

Preferably, the adhesive receiving area comprises incisions which extend substantially in the transverse direction of the container, which is a direction substantially perpendicular to the pull direction in between the lid and cover flap when opening the container lid. In particular, a hinge line in between the lid and the box of the container also extends in the transverse direction. The orthogonal arrangement of the incisions regarding the main force direction enables that the pulling force during opening of the lid is transmitted from the cover flap into the open surface structure of the panel, and distributed evenly throughout the adhesive receiving area. Therefore a strong bond in between the cover flap and panel is enabled.

The term “blank” is used to refer to a single, continuous portion of sheet-like material, such as cardboard, paper or a polymer sheet.

The term “panel” is used herein to refer to a portion of the blank. A panel may depend from one or more other panels.

The term “tab” refers to a panel, which depends from only one other panel.

The term “wall” refers more generally to a facet of the container, and a wall may be formed from a single panel, or a wall may be formed from two or more panels depending from each other.

The term “depending” is used herein to describe a physical connection between two elements of a container or element of the container. In more detail, the term “depending” is used to indicate that there is a material continuity between two elements, such as two walls or panels of a container or blank. A side wall or panel may depend directly from an adjacent panel or flap. In such case, the wall or panel typically depends along a fold line from the adjacent wall or panel.

The term “line of weakness” is used herein to describe a portion of a surface of the container (or the blank from which the container is formed) wherein the structural strength of the material, from which the container (or blank) is formed has been weakened by any suitable technique, for example with respect to bending, folding or tearing along the line of weakness. For example, a line of weakness may be formed as a scoring line, a creasing line, an ablation line, or a perforation line. Lines of weakness can be created by removal of material, by displacement of material, by compression of material, by locally reducing the forces that hold the material together, such as by breaking fibres in a fibrous material, as well as by combinations of all the above. A line of weakness may be straight, curved, segmented or continuous or a combination thereof. In many instances, a line of weakness is used to assist in positioning a fold line in a blank. A line of weakness can also be used to strengthen the material in a direction perpendicular to the line of weakness, for example by compression. Further, a line of weakness can be used for decorative purpose.

The term “scoring” is used to describe the forming of a curve, line or area by partially cutting into the material of the blank. A scoring curve or line may be formed by removing material from the blank (in which case the scoring curve or line forms a groove or trough in the blank). As an alternative, a scoring line may be formed without removing a significant amount of material from the blank, typically involving a partial sideways displacement and compression of material, caused by a knife with a non-zero thickness penetrating the material. The depth of a scoring line will be less than the thickness of the blank. In particular, “scoring” involves both depressing and scratching or roughening the material of the panel. Scoring creates a depression with an open surface structure, wherein the level of openness of the surface structure depends on the particularities of the scoring process.

The term “creasing” is used to describe the forming of a straight or curved line or area by displacing a portion of the material vertical to the plane of the blank, forming a groove or trough in the blank. The displacement may involve compression and typically involves the use of a compression tool, such as a roller. Alternatively, or in addition, the material in the creasing line may be displaced so as to at least partially protrude from the opposite side of the blank. Generally, no material is removed when a creasing line is formed.

The term “ablation” is used to describe the forming of a curve, line or area by removing material from a surface of the blank to a predetermined depth by way of ablation (for example, by way of a laser beam or a blade).

The term “perforation” is used to describe a curve, line or sequence of discrete holes, incisions or slots in the blank. The holes may be formed by pushing an object through the blank. This may result in material being removed from the blank, for example by punching. Alternatively, the holes could be created without removing material, and instead simply using the object to push the material outwardly from the centre of the hole. As another alternative, the holes may be formed by way of a laser beam.

The term “fold line” is used to describe any line of a blank about which the blank is folded. The fold line may be defined by a line of weakness to assist with the folding action. Alternatively, a fold can be formed without the presence of a weakening line. In such embodiments, a fold line is typically defined by the end points between the fold forms when bending the sheet like material, depending for example on the pliability of the blank material and other material characteristics.

The term “embossing” is used to describe the creation of raised and recessed relief structures in the blank, in particular by applying pressure with corresponding dies from both sides to the blank.

The adhesive is preferably a viscous fluid. Preferably, the adhesive is applied in the form of several glue dots on the adhesive receiving area of the panel or the further component. During construction of the container, the at least one container wall and the further component are brought into contact with each other, in particular by applying pressure, and the adhesive is distributed by means of the pressure, wherein the adhesive interaction portion prevents the traveling of the adhesive to an undesired location.

The fixation of the adhesive receiving area of the panel to the further component relates in particular to a permanent connection. The term “permanent connection” is used herein to refer to a connection between two panels or a panel and a further component, such that the connection is not separable under normal handling conditions of the container. Such a permanent connection may be achieved by a high tack or permanent adhesive like for example, hot melt. In contrast, the term “non-permanent connection” is used to indicate a connection between two panels or other container components that may be opened under normal handling conditions. Such a permanent connection may be achieved by a low tack adhesive.

The fluid guide element is formed as a local height variation. In addition, the fluid guide element may have other physical or chemical properties that influence the progression of adhesive on the panel it is applied to. In particular, the fluid guide element may be intended to influence the progression by stopping or hindering the adhesive from advancing into a predetermined direction for example by non-mechanical means. Alternatively, or in addition, the fluid guide element may be intended to promote the adhesive into advancing into a predetermined direction, for example by non-mechanical means. For example, the fluid guide element may have a particular surface coating, for example coatings that are lipophobic, hydro-phobic, repellent or attractive, or may influence locally the viscosity of the adhesive, depending on what type of adhesive is used. Further, the area of the fluid guide element may have a certain different roughness or coefficient of friction compared to the base material of the panel. The different roughness or coefficient of friction may prevent the adhesive to advance or slows the adhesive sufficiently to prevent the smearing of the adhesive into unwanted areas. Alternatively, the different roughness or coefficient of friction of the panel with the fluid guide element may accelerate the distribution of the adhesive into a predetermined area, thus preventing the adhesive from smearing into unwanted areas. For example, such a fluid guide element may be applied to the panel by a print, spray or coating process. In a preferred embodiment, the fluid guide element forms a closed frame of the central adhesive receiving area onto which the adhesive is applied.

The terms “front”, “back” or “rear”, “upper”, “lower”, “side”, “top”, “bottom” and other terms used to describe relative positions of the components of containers according to the invention refer to the container in an upright position with the lid at the top end and the hinge on the back. The terms “left” and “right” are used with reference to side walls of the container when the container is viewed from the front in its upright position. When the container in the upright position is open, the aerosol generating articles contained in the box may be removed from the upper end of the container. The term “longitudinal” refers to a direction from bottom to top or vice versa the term “height direction” is used to indicate a direction parallel to the longitudinal direction. The term “transverse” refers to a direction perpendicular to the longitudinal direction across the front wall, the back wall or one of the side walls. The terms “depth direction” and “width direction” are used to indicate transverse directions across the depth of the container or the width of the container, respectively.

The term “hinge line” refers to a line about which the lid may be pivoted in order to open the container. A hinge line may be, for example, a fold line or a score line in the back wall of the container. Alternatively, a hinge line may be a fold line or a score line in a piece of material bridging the lower edge of the back wall of the lid and the upper edge of the back wall of the box. Such a piece of material may be, for example, a label that is permanently or removably attached to the back wall of the lid and the back wall of the box. Preferably, the hinge line is positioned along the back wall of the container at a level below the upper edge thereof.

Preferably, the container further comprises an inner frame mounted within the box, wherein the inner frame extends above the upper edges of at least the front wall of the box of the container. The inner frame is therefore visible to the consumer when the lid is opened. The front wall of the inner frame may be printed with indicia which may be the same as, or different to the indicia printed on the front wall of the box. Alternatively, or in addition, the front wall of the inner frame may be cut into a distinctive shape, for example, to reflect the branding of the consumer goods. If required, the inner frame may also comprise a line of weakness to facilitate flattening of the container.

Preferably, the front wall of the inner frame is provided with a cut out portion at the upper edge thereof. This enables more convenient access to the consumer goods within the container, without significantly reducing the surface area of the front wall of the inner frame.

Alternatively, or in addition to an inner frame, the consumer goods within the container may be wrapped with the inner liner, which is visible above the upper edge of the front wall of the box and the front wall of the inner frame (if present) when the container is open.

Containers according to the invention may be in the shape of a rectangular parallelepiped, with right-angled longitudinal and right-angled transverse edges. Alternatively, the container may comprise one or more rounded longitudinal edges, rounded transverse edges, bevelled longitudinal edges or bevelled transverse edges, or combinations thereof.

The exterior surfaces of containers according to the invention may be printed, embossed, debossed or otherwise embellished with manufacturer or brand logos, trade marks, slogans and other consumer information and indicia. Alternatively, or in addition, the exterior surfaces of containers according to the invention may be at least partially covered with lacquer, metallisation, holograms, luminescent material, or any other materials that alter the feel, odour or appearance of the container.

Where the inner housing of a container according to the present invention contains one or more bundles of aerosol generating articles, the aerosol generating articles are preferably wrapped in an inner liner of, for example, metal foil or metallised paper.

Where the container comprises aerosol generating articles, the container may further comprise waste-compartments (for example for ash or butts) or other consumer goods, for example matches, lighters, extinguishing means, breath-fresheners or electronics. The other consumer goods may be attached to the outside of the container, contained within the container along with the aerosol generating articles, in a separate compartment of the container or combinations thereof.

Once filled, containers according to the invention may be shrink wrapped or otherwise over wrapped with a transparent polymeric film of, for example, high or low density polyethylene, polypropylene, oriented polypropylene, polyvinylidene chloride, cellulose film, or combinations thereof in a conventional manner. Where containers according to the invention are over wrapped, the over wrapper may include a tear tape. The tear tape is preferably positioned around the container below the lower edge of the front wall of the lid, such that once the tear tape has been removed, the lid is free to be rotated about the first hinge line. Alternatively, the tear tape may be provided lengthways around the container.

The invention will now be further explained with reference to exemplary embodiments as shown in the following figures.

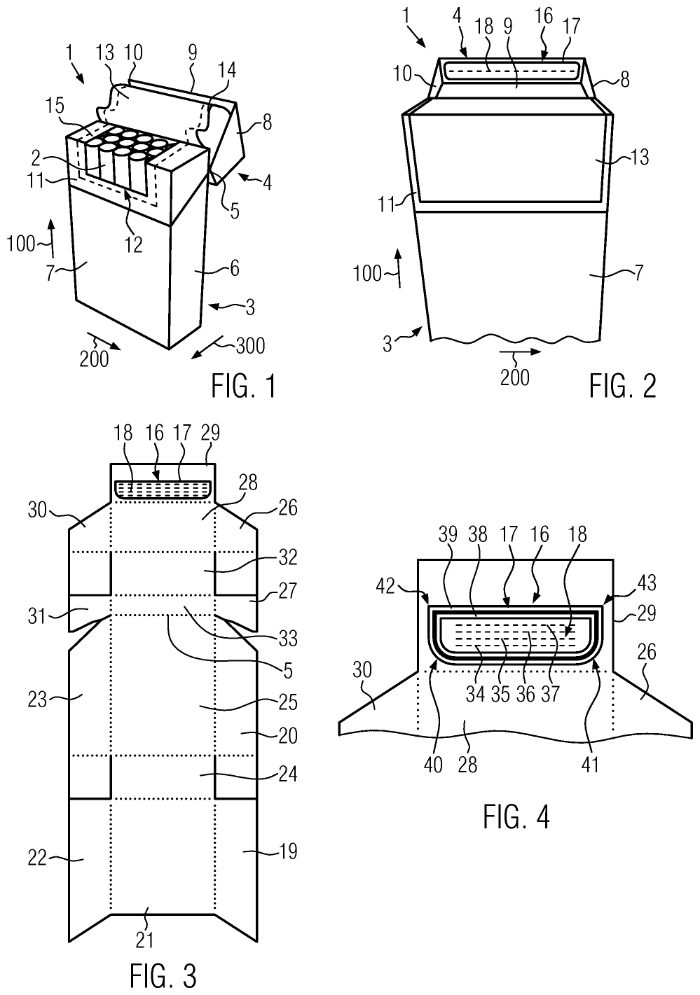

FIG. 1 shows a perspective view of a container according to an embodiment of the invention;

FIG. 2 shows a frontal perspective view of a container according to the embodiment of the invention;

FIG. 3 shows a plan view of a blank for forming a container according to the embodiment of the invention; and

FIG. 4 shows a magnification of the lid front wall panels of the blank according to FIG. 3.

In FIG. 1, a container 1 according to an embodiment of the invention is shown in a perspective view. The container 1 comprises several smoking articles 2, in particular cigarettes. The smoking articles 2 are each oriented in the longitudinal direction, which corresponds to the height direction 100, when the container 1 is in the upright orientation as shown in FIG. 1. The smoking articles 2 are arranged in several rows, in which smoking articles are provided adjacent to each other in the width direction 200. In particular, three rows of smoking articles 2 are provided parallel to each other in the depth direction 300 of the container 1.

The container comprises a box 3, which is substantially cup-shaped, and a lid 4, which is hingedly attached via a hinge line 5 at an upper end of a box back wall. The container box 3 further comprises a box right side wall 6, a box front wall 7, a box left side wall, and a box bottom wall. The lid 4 of the container 1 comprises a lid back wall attached via the hinge line 5 to the box back wall, a lid right side wall 8, a lid front wall 9, a lid left side wall 10 and a lid top wall. The respective container walls are arranged substantially perpendicular with respect to their adjacent container walls, such that the container 1 is substantially a cuboid, when the lid 4 is in its closed position.

In the container 1 an inner liner11 is provided, which comprises the smoking articles 2. The inner liner 11 serves the purpose of preserving the freshness of the smoking articles 2. This is particularly important, if the smoking articles 2 comprise volatile components, such as for example, menthol flavor, which may otherwise evaporate. The inner liner 11 comprises an opening 12 extending from the upper front side to the upper side of the box. The opening 12 can be closed by a cover flap 13. The inner liner 11 may fully enclose the smoking articles 2. The inner liner 11 may at least be partially formed by a metallised foil. The cover flap 13 is provided as a separate label, fixed with permanent adhesive at the rear side of the opening 12. In the outer region 14 at the front and sides of the cover flap 13 and/or in the region 15 below and at the sides of the opening 12, non-permanent, low tack adhesive is provided to enable the sealing of the opening 12 by means of the cover flap 13.

To enable that the cover flap 13 is opened, when the lid 4 is hinged into an open position as shown in FIG. 1, the cover flap 13 is fixed by means of permanent adhesive, in particular permanent glue, to the inner side of the lower end of the lid front wall 9. As the adhesive is supplied very close to the corner edge of the lid front wall, on one hand, there is the risk that some of the adhesive would come in contact with the box of the containers known in the prior art. This could cause that the lid 4 and the box 3 are involuntarily fixed together by means of adhesive, preventing a smooth opening of the container 1. On the other hand, it is very important that the connection in between the cover flap 13 and the lid 4 does not fail, as then the opening of the cover flap 13 would not be effected anymore by opening the lid 4. In FIG. 2, the container 1 is shown in a perspective upper front side view, wherein the lid 4 is again in the open position with respect to the box 3. However, the cover flap 13 is not yet fixed to the lid 4, and therefore, it still remains in its closed position covering the opening 12 of the inner liner 11.

At the inner side of the lid front wall 9, an adhesive interaction portion 16 is provided, comprising an outer fluid guide element 17 and a central adhesive receiving area 18.

In the central adhesive receiving area 18 openings are provided in the surface structure of the inner lid front wall 9. The opening may enable to increase the surface of the wall interacting with the adhesive. In particular, in the central adhesive receiving area 18, at least one perforation line is provided, which is formed by several subsequent incisions into the material of the lid front wall 9 along a line.

The outer fluid guide element 17 is a depressed channel, extending fully around the central adhesive receiving area 18. The cover flap 13 is connected to the lid 4, by a permanent adhesive connection in between the outside of the cover flap 13 in the region near the lower edge of the closed cover flap 13, as seen in FIG. 2 and the inner side of the lid front wall 9 in the region of the central adhesive receiving area 18.

In FIG. 3, a blank according to an embodiment of the invention is shown, which enables to form a container according to an embodiment of the invention. In the blank according to FIG. 3, dotted lines indicate folding lines via which the panels depend from each other.

The box right side wall is formed by the outer box right side wall panel 19 and the inner box right side wall panel 20, the box front wall 7 is formed by the box front wall panel 21, the box left side wall is formed by the outer box left side wall panel 22 and the inner box left side wall panel 23. The box bottom wall is formed by the box bottom wall panel 24, and the box back wall is formed by the box back wall panel 25.

The lid right side wall is formed by the outer lid right side wall panel 26 and the inner lid right side wall panel 27. The lid front wall 9 is formed by the outer lid front wall panel 28 and the inner lid front wall panel 29. The lid left side wall 10 is formed by the outer lid left side wall panel 30 and the inner lid left side wall panel 31. The lid top wall is formed by the lid top wall panel 32. The lid rear wall is formed by the lid rear wall panel 33. The lid rear wall panel 33 and the box rear wall panel 25 depend from each other via the hinge line 5.

The respective panels forming the container walls are connected to each other by means of adhesive. Not shown in the figures, the inventive adhesive interaction portion may be provided on any of these panels, preferably on the outside of the respective inner panel forming a container wall.

The inner lid front wall panel 29 has the same width and a height of at least 50% of the outer lid front wall panel 28. Depending on the embodiment, the inner lid front wall panel 29 has the same size or at least at least 90% of the size, at least 80% of the size, at least 70% of the size or at least 60% of the size of the outer lid front wall panel 28. This enables a stable connection in between the outer lid front wall panel 28 and inner lid front wall panel 29 by means of adhesive.

In particular, the blank is made from a coated cardboard material, i.e. a cardboard material which is provided on the outside thereof with a coating, preferably in the form of a polymer film. In other embodiments, the blank may be manufactured from a highly compact cardboard. These materials share the property that their surface is substantially closed.

To enable a strong permanent connection of the cover flap 13 with the inner lid front wall panel 29, the material of the inner lid front wall panel 29 is opened in the central adhesive receiving area 18, in particular by providing four parallel perforation lines 34, 35, 36, 37. The perforation lines 34, 35, 36, 37 break the closed surface of the panel 29 to allow a penetration of the adhesive into the panel 29. Preferably, the perforation lines 34, 35, 36, 37 are formed by several subsequent incisions each.

The incisions may fully or partially penetrate the inner lid front wall panel 29. As the inner lid front wall panel 29 is not visible from the outside of the closed container, but only the outer lid front wall panel 28, fully penetrating incisions are not visible from the outside of the container. In other embodiments only one, two, three, five or more than five parallel perforations lines may be provided. Instead of a straight perforations line, a perforation curve may be provided. Several perforation curves may be arranged in parallel.

The length of the lowest perforation line 34 may be shorter than the length of the other perforation lines. The other perforation lines 35, 36, 37 may have the same length.

In the present embodiment more than 100 cuts are provided in total for all perforation lines

Preferably, more than 20 cuts per perforation line may be provided.

Each cut may have a length of 0.5 mm (millimeters) to 1.5 mm, preferably 1 mm. The distance in between the incisions in the perforation line may be equal to or more than 0.25 mm or equal to or more than 0.5 mm, preferably 0.5 mm.

In embodiments, where the perforation lines fully penetrate the inner lid front wall panel 29, they may also have a positive effect on the adhesive connection in between the outer lid front wall panel 28 and the inner lid front wall panel 29.

The adhesive for the connection in between the outer lid front wall panel 28 and inner lid front wall panel 29 is provided on the other side of the inner lid front wall panel 29 than the adhesive in the adhesive interaction portion. The inner lid front wall panel 29 is generally folded by about 180 degrees from the position as shown in FIG. 3 onto the inner side of the outer front lid wall panel 28 and permanently connected thereto by means of adhesive. The adhesive for connection of the panels 28, 29 may be provided in a separate region of the inner lid front wall panel 29 than the adhesive interaction portion 16.

The arrangement of the adhesive interaction portion 16 in the inner lid front wall panel 29 enables that same not visible from the outside of the closed container 1, even if the outer fluid guide element 17 is formed by embossing or debossing, which deforms both sides of the inner lid front wall panel 29.

The adhesive interaction portion 16 on the inner lid front wall panel 29 is shown in more detail in the magnification of FIG. 4.

The adhesive interaction portion 16 comprises the outer fluid guide element 17, which fully encompasses the central adhesive receiving area 18. The outer fluid guide element 17 is formed by two parallely extending local height variations 38, 39, in particular in the form of a debossed channel, respectively. The local height variations 38, 39 provide a reservoir for receiving surplus adhesive which is distributed when the cover flap 13 is pressed to the adhesive interaction portion 16 with a liquid adhesive arranged in between. The depth of the local height variations in the form of the debossed channels is preferably in between 8-20 μm (micrometers). Thus, a reliable bonding in between the cover flap 13 and the inner lid front wall panel 29 can be obtained, while the double debossed channels prevent that adhesive travels outside the outer fluid guide element 17.

Preferably, at the lower right and left corners 40, 41 of the outer fluid guide element, a radius is provided for the local height variations 38, 39 in form of the double debossed channels. However, at the upper right and left corners 42, 43 of the local height variations 38, 39, a lower radius or even a perpendicular corner is provided. An accordingly formed outer fluid guide element 17 may provide a beneficial transmission of force in between the cover flap 13 and the adhesive interaction portion 16 via the adhesive.

The lower side of the outer fluid guide element 17 with the rounded corners 40, 41 enables that adhesive is maintained in a distance from the edge of the cover flap 13, and may thus prevent that adhesive reaches the region where an involuntary connection of the lid to the box could occur.

In the following, an embodiment of a method according to the invention will be explained. Initially, a blank is cut from a cardboard material, having the shape and cutting lines as shown in FIG. 3. The material of the blank has a closed surface, in particular a compressed cardboard surface or a surface coating, for example by a polymer coating.

The blank is provided with folding lines shown as dotted lines in FIG. 3, preferably in the form of creasing lines. A fluid guide element 17 with two parallel local height variations 38, 39 in the form of a double debossed channel is formed in the lower part of the inner lid front wall panel 29 by means of an embossing tool. The fluid guide element 17 encompasses a central adhesive receiving area 18. Several incisions, in particular in the form of perforation lines 34, 35, 36, 37 are cut with a knife in the central adhesive receiving area 1, breaking the surface of the blank. This allows that liquid adhesive may penetrate into the panel in a later step of the method.

An inner liner 11 is cut from an inner liner material, preferably a metallised paper or a polymer foil. The inner liner 11 comprises an opening 12, which is closed by means of a cover flap 13. The cover flap 13 is permanently connected to the remaining inner liner 11 at one side of the opening 12 using permanent adhesive, and on the other three sides of the opening 12 using non-permanent, re-stick adhesive.

Then, the inner liner 11 is folded around a bundle of smoking articles 2 and closed by adhesive connections. Preferably, the inner liner 11 provides a gas-tight packaging for the smoking articles, to preserve their freshness.

The inner liner 11 together with the smoking articles 2 is then arranged on the aforementioned blank, and the blank is wrapped around same, wherein the respective panels forming the walls are connected by means of adhesive to each other.

To permanently connect the cover flap 13 to the inner side of the lid front wall 9, liquid adhesive is provided in the region near the lower edge of the closed cover flap 13 and/or on the inner side of the lid front wall 9 inside the central adhesive receiving area 18. The adhesive is applied in a viscous liquid state and travels, when the inner lid front wall 9 is pressed against the cover flap 13. In particular, the adhesive travels into the openings in the surface structure of the central adhesive receiving area 18 and at least partially to and into the outer fluid guide element 17, which receives any unnecessary surplus of adhesive and therefore prevents that same flows outside the area encompassed by the outer fluid guide element 17. Furthermore, the outer fluid guide element 17 enables that adhesive travels along its extension direction and therefore supports the distribution of adhesive in the whole of the adhesive interaction portion 16. The adhesive interaction portion 16 enables a stable connection in between the lower side of the cover flap 13 and the inner side of the lid front wall 9.

The connection in between the cover flap 13 and the inner side of the lid front wall 9 may be effected at the same time as the connection of the panels of the container 1 to each other. Furthermore, the inner liner 11 may be connected by adhesive to the inner side of at least one wall of the box 3, where an inventive adhesive interaction portion may be provided.

When the container 1 is opened by hinging the lid 4, the cover flap 13 is automatically lifted, while the non-permanent re-stick connection in between the cover flap 13 and the inner liner 11 opens. Accordingly, the smoking articles 2 can be accessed through the opening 12 as shown in FIG. 1. When the container 1 is closed, the cover flap 13 moves together with the lid 4 and is brought back into the non-permanent, re-stick connection with the inner liner, closing the opening 12 substantially gas-tight. Due to the inventive adhesive interaction portion 16, it is possible that the container 1 may be opened and closed many times, without failing of the adhesive connection in between cover flap 13 and the lid front wall 9.

1. A method of forming a container for aerosol generating articles, comprising the following steps:
i) providing a blank comprising at least one panel,
ii) opening the surface structure of the panel in a central adhesive receiving area, and
iii) creating by embossing a local height variation in the panel, wherein the local height variation extends as an outer fluid guide element at least partially at the outside of the central adhesive receiving area,
wherein the central adhesive receiving area and the outer fluid guide element form an adhesive interaction portion in the panel.

2. The method according to claim 1, wherein the fluid guide element is continuous but at least partially non-linear, such that it at least partially encompasses the central adhesive receiving area.

3. The method according to claim 1, wherein the step ii) of opening comprises cutting the panel in the adhesive receiving area.

4. The method according to claim 1, wherein the step ii) of opening comprises scratching or roughening the panel in the adhesive receiving area.

5. A blank for forming a container, wherein the blank comprises several panels,
wherein at least one panel comprises an adhesive interaction portion, and wherein the adhesive interaction portion comprises an adhesive receiving area which is at least partially encompassed by a continuous, at least partially non-linear fluid guide element created by embossing.

6. The blank according to claim 5, wherein the fluid guide element fully and continuously encompasses the adhesive receiving area.

7. The blank according to claim 5, wherein the fluid guide element is formed by a depression in the panel.

8. The blank according to claim 5, wherein the fluid guide element is formed by two parallel depressions in the panel.

9. The blank according to claim 5, wherein in the adhesive receiving area, the surface structure of the panel is opened.

10. The blank according to claim 5, wherein in the adhesive receiving area, several subsequent incisions along a perforation line are provided.

11. The blank according to claim 5, wherein in the adhesive receiving area, incisions in several parallel perforation lines are provided.

12. A container for consumer goods, wherein the container is formed from a blank according to claim 5,
wherein a container wall is formed from at least one of the panels, and
wherein adhesive is provided in the adhesive receiving area of the adhesive interaction portion.

13. The container according to claim 12, wherein the adhesive connects a cover flap of an inner liner to a lid of the container.

14. The container according to claim 13, wherein the blank is made of cardboard and the cover flap comprises a polymer film, in particular metallised film.

15. The container according to claim 13, wherein the adhesive receiving area comprises incisions which extend substantially in the transverse direction of the container, which is a direction substantially perpendicular to the pull direction in between lid and cover flap when opening the container lid.
